(19) United States
(12) Patent Application Publication
(10) Pub. No.: US 2006/0080293 A1
(43) Pub. Date: Apr. 13, 2006

(54) Procedure and mechanism for searching for information in databases

(75) Inventor: Vincent Nahum, Neuilly / Seine (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: INFINANCIALS, Paris (FR)

(21) Appl. No.: 11/041,294

(22) Filed: Jan. 25, 2005

(30) Foreign Application Priority Data
Oct. 13, 2004 (FR) 04 10787

(51) Int. Cl. G06F 17/30

(52) U.S. Cl. 707/3

(57) ABSTRACT

The invention relates to a procedure for searching for data through a number of databases, each of which contains a large number of data items of a first given type, each associated with at least one data item belonging to a second data type. For a reference data item, the procedure covers the search for data of the second type associated with the reference data item, the number of data items of the first type associated with each data item of the second type, and then the allocation of a coefficient known as the “relevance weighting” (a function of the number of data items of the first type associated with the particular item of the second type) to each set of data of the first type associated with the data item of the second type.

### TECHNICAL FIELD AND PRIOR-ART

The invention relates to a procedure for searching for information within databases. It also similarly concerns a search engine allowing information to be identified within databases that do not use the same data classification criteria.

It is particularly (though not exclusively) applicable in fields such as those involving finance.

Within that field, a search is effectively performed to identify companies that are comparable to a given company.

In other terms, then, a search engine is needed that allows a group of companies with similar or competitive activities to be identified within one or more financial databases.

Traditionally, financial databases contain lists by sector that allow the enterprises to be classified according to various sector-based groupings (classification types Dow Jones, SIC, NAICS, FT, MG and MSI).

Each of these classifications has its own defects:

none of them is exhaustive: all companies are not classified using any given classification, only a subset,

each of them is arbitrary and may work well for one activity or one company while being very imprecise or abstract for another,

each of them is reductive in nature, often tending to associate a single company with a single activity, even though particular companies are often involved in several activities (a 1-to-1 relationship instead of 1-to-many),

finally, they are often devised either for (governmental or administrative) economic purposes or for managers, with the aim of carrying out indexed investment management.

So they produce few if any answers to the peer-to-peer-search problem, i.e. to find the companies close by, starting from a given company.

This problem is certainly a critical one for some very important companies. But in general, these companies have the means to know who their competitors are and can easily identify them. Nevertheless, this information—which is in principle internal to the company—is not necessarily made available to third parties and in particular to those who may belong to the same market segment but on a smaller scale.

Moreover, even if a company can identify other comparable concerns, the classification that they give may not necessarily be the most pertinent or indeed the only one. On the markets, such as the stock markets for example, there are classifications belonging to each stock exchange index, for example the CAC or the Dow Jones. And it is important to be able to take other classifications into account.

The same problem is posed, and put in sharper relief too, with companies of a more modest scale that do not have the means to identify which other companies among the many that exist may have activities comparable to their own.

This information is all the more important since it then allows all sorts of comparisons to be made between the companies identified: not only in terms of the turnover, but also growth, ratios, etc.

To improve the searches, cross-referencing the sector-based codes could therefore be considered: traditional search tools allow different sector-based classifications to be combined using Boolean logic (combinations of operators such as AND, OR, NOT etc.).

This approach generates deceptive results, since the defects of the different sector-based classifications are accumulated.

The same problems would arise when searches are made through information held in databases that are different in nature, making use of non-homogenous classifications across them, prioritising this or that criterion in a way that varies from one database to another.

The problem posed is therefore to find a procedure and the means to search through varying databases that present you with heterogeneous classifications and variable classification criteria.

### SUMMARY OF THE INVENTION

The invention first concerns a method for searching for data through a plurality of databases, each of which contains a plurality of data items of a first given type, each associated with at least one data item belonging to a second data type. The method comprises:

A—inputting a data item of the first data type, referred to as the reference data item, B—in each database:

B1 —searching for data items of the second type, associated with the reference data item,

B2—for each data item of the second type associated with the reference data item, finding the number of data items of the first type associated with said data item of the second type,

B3—allocating a coefficient known as the relevance weighting, function of the number of data items of the first type, to each set of data items of the first type associated with said data item of the second type.

The invention also concerns a method for searching for data through a plurality of databases, each of which containing a plurality of data items of a first given type, each associated with at least one data item belonging to a second data type. This method comprises:

A—inputting a data item of the first data type, referred to as the reference data item,

B—the selection from said plurality of databases of data items of the second type, referred to as second data type items associated with the reference data item, followed by:

B1—for each data item of the second type associated with the reference data item, searching the number of data items of the first type associated with said data item of the second type,

B2—allocating to each set of data items of the first type associated with said data item of the second type, a coefficient, known as the relevance weighting (a function of the number of data items of the first type associated with said data item of the second type).

This other method assigns one or more data items of the second type to a data item of the first type that is not included in one of the databases, insofar as they have data items of the first type; this other procedure then runs in the same way as the previous one.

Each of these methods differs from the familiar database search procedures and is not restricted to searches using Boolean operators across different databases.

Each of these methods has been proven to produce much more relevant results than the well-known procedures.

A display step can be envisaged for each database and for each item of the second data type associated with the reference data item. The number of first-type data items-associated with this second-type data item, as well as the corresponding relevance weighting can thus be displayed.

It is equally possible to display the second-type data items associated with the reference data item found in any of the databases, the number of data items of the first type associated with this second-type data item and the corresponding relevance weightings.

Each of these methods can further comprise the calculation of a relevance coefficient as a function of at least the relevance weighting, for at least each first-type data item associated in at least one database.

The relevance coefficient can be calculated as a function of the sum of the relevance weightings given to the second-type data items associated with the reference data item.

Each of these methods can further comprise displaying the first-type data items for which the relevance coefficient is not zero.

The data items of the first type may be the names of companies and the databases may for example be financial or stock exchange databases containing at least the classifications used by Dow Jones and/or the Financial Times and/or NAICS (North American Industry Classification System) and/or SIC (Standard Industry Classification) and/or GIGS.

The databases can reside on a single server or on different servers.

The invention thus allows sector-based approaches to be combined, but according to a procedure based on a score calculation. According to one method of implementation, this procedure can employ 3 steps:

the definition, automated or otherwise, of a profile modelled on a reference company,

updating and validating the profile,

calculating the score for the set of companies in the database and displaying the scores or the best scores in decreasing order.

The invention further concerns a device for searching for data through a number of databases, each of which contains a plurality of data items of a first given type, each associated with at least one data item belonging to a second data type. This device comprises:

a search means searching or selecting the following from each database:

data items of the second type, associated with the reference data item,

for each second-type data item or at least one data item of the second type associated with the reference data item, the number of first-type data items associated with the said data items of the second type,

allocating means allocating a coefficient known as the “relevance weighting” (a function of the number of first-type data items) to each set of data items of the first type associated with said second-type data item.

Display means allow (for each database and for each item of the second data type associated with the reference data item) the number of first-type data items associated with this second-type data item to be displayed, as well as the corresponding relevance weighting.

Display means allow the second-type data items associated with the reference data item found in any of the databases to be displayed, as well as the number of data items of the first type associated with this second-type data item and the corresponding relevance weightings.

In a further embodiment, means of calculation calculate a relevance coefficient as a function of at least the relevance weighting, for at least each first-type data item associated in at least one database.

The relevance coefficient can be calculated as a function of the sum of the relevance weightings given to the second-type data items associated with the reference data item.

Display means allow (for each database and for each item of the second data type associated with the reference data item) the number of first-type data items associated with this second-type data item to be displayed, as well as the corresponding relevance weighting.

The invention further concerns a computer program comprising the instructions for implementing a method as described in this invention, along with data storage media capable of being read by a computer system, containing data in encoded form required to implement a method according to the invention.

The invention further concerns a computer program comprising the instructions for implementing a method according to the invention, a computer readable product comprising data storage media suitable for being read by a computer system, to implement a method according to the invention.

### BRIEF DESCRIPTION OF THE DRAWINGS

FIGS. 1 and 2 provide a schematic representation of an example system for implementing the invention.

FIG. 3 shows a schematic representation of a database.

FIG. 4 gives a schematic representation of the steps of a method according to the invention.

### DETAILED DESCRIPTION OF PARTICULAR EMBODIMENTS

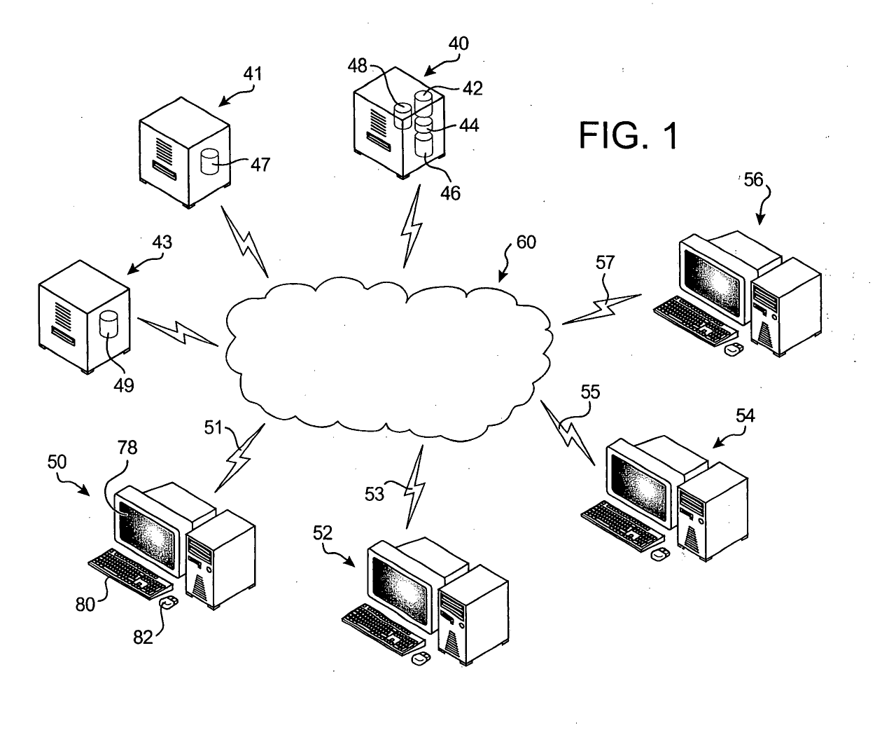

Means for implementing this invention will be described in conjunction with FIGS. 1 and 2.

References 40, 41 and 43 in FIG. 1 designate a plurality of computers, servers or other electronic locations (hereinafter the terms “server” or “platform” will be used, but these can be understood as “computer” or “electronic site” as well) upon which different users, each with their own data equipment such as for example a microcomputer of the PC type (50, 52, 54, 56 . . . ), can be connected or can have access through a network (60) such as the Internet. Each of these users accesses the network via his own connection (51, 53, 55, 57 . . . ) and has his own address.

The users' machines can also be portable terminals with a means of connection or means of communication with the servers (40, 41 and 43).

Each server records data on its storage media (42, 47, 49), for example as a data dictionary or database (B0, B1, B2) containing a collection of elements. Various users can search through said different databases for information correlated with or associated with the data (i.e. the reference data) each of them has input.

In one variant, a single server (40) has been supplied with data from various other servers and it brings together the entirety of the information from all other databases. So, each user only has to interrogate a single server in order to be able to examine the entirety of the information in all the databases.

Nevertheless, the formats of the various databases will generally be different from one another. In that case, the server that puts together the data from the different databases converts all the information into a unique format.

Hereinafter, the example used will concern the case of economic data about companies, but the invention is not restricted to this example and other applications could be considered.

FIG. 2 gives a block diagram showing the various components of a data processing device (50). A microprocessor (70) is connected over a bus (72) to a collection of RAM memories (74) for storing data, and to a ROM memory (76) which can be used for recording program instructions. The items contained in this system include a display device (78) or screen and peripherals (80 and 82, keyboard and mouse).

Reference 84 represents means of interfacing with the network, such as a modem. The other devices (52, 54 . . . ) can contain the same elements. The structure of the server is broadly the same, with processor(s), data storage areas (shown elsewhere in FIG. 2 by references 42, 44, 46 and 48) and a network connection.

As a general rule, each user machine contains a means (78) of displaying data transmitted by the computer (40) over the communication and/or transmission devices (51, 53, 55, 57 and 60).

It also has a means (80) of entering requests with the aim of extracting particular data from the database or databases. These data are transmitted to one of the servers (40, 41 and 43) via the communication and/or transmission devices (51, 53, 55, 57 and 60).

Each of the machines (50, 52, 54 and 56) can be supplied with a spreadsheet, a software application as described in document FR-2 839 567.

It could also be provided with a navigator, a programme allowing the web to be used and in particular to search and examine documents and to use the hyperlinks they contain.

A user's data processing device is programmed (or the data or instructions for the program are stored in a memory area of the data processing equipment of at least one user) for the implementation of a method according to this invention and in particular for inputting a request (for example of an SQL type) for particular data to be sent and for receiving data from one or more databases in response.

Equally, each server (or the server that collates the data from the various databases) is equipped to handle the user requests.

Each server (or the server that centralises and handles the requests) is programmed (or data or program instructions are stored in a memory area on the server or servers) for the implementation of a method according to the present invention.

In each case, these data or programmed instructions can be transferred to a memory area within the server (40) or the user's machine, using a disk or any other medium (e.g. hard disk, static ROM memory, writable dynamic DRAM memory or any other type of RAM storage, CD, magnetic or optical storage device) capable of being read by a microcomputer or a data processing device.

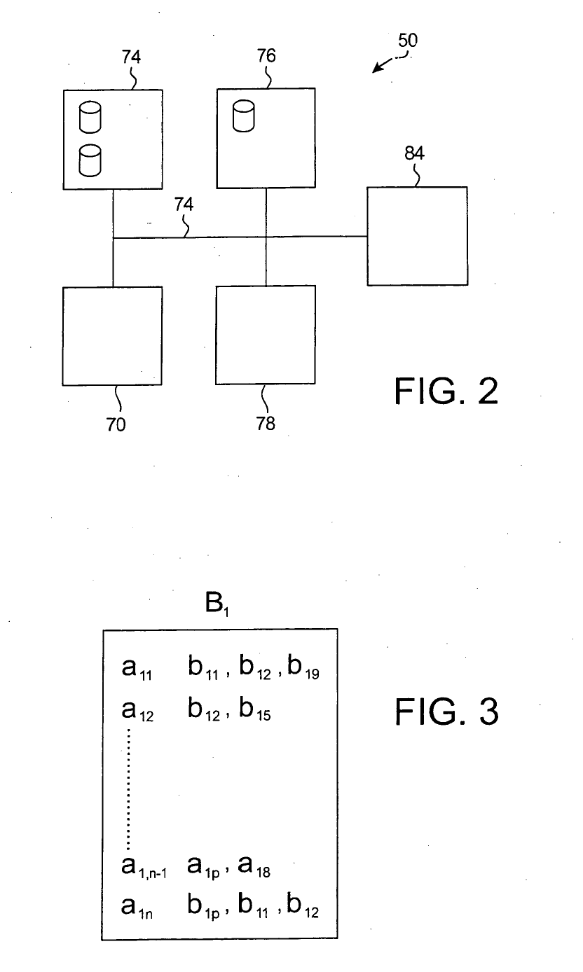

An example method according to the invention will be described in conjunction with FIG. 3.

Each database Bᵢ contains data aᵢₖ, where k=1 . . . ni, referred to here as the first data type.

Each data item of the first type in database Bᵢ is associated with one or more data items (in the same database Bᵢ) of a second type bᵢₗ, where l=1 . . . pᵢ.

For example, as illustrated in FIG. 3, the following are associated in the database B₁:

second-type data items b₁₁, b₁₂ and b₁₅ are related to the first item a₁₁ of the first data type,

second type data items b₁₂ and b₁₅ are related to the second item a₁₂ of the first data type,

second type data items b₁ₚ and b₁₈ are related to item n−1 of the first data type, a_{1,n-1}.

second type data items b₁ₚ, b₁₁ and b₁₂ are related to the nth item a₁ₙ of the first data type.

One or more data items of the first type are associated with each data item of the second type.

The data of the first type can therefore be classified in each database into groups of items having a common data item of the second type. However, this classification is not available and, for a given first data item of the first type, it would be necessary to run through the entire database to identify first-type data items having a second-type data item in common with the said given first data item.

It would be necessary to go through the next database to find the same first-type data item, if present, along with the first-type data items in this second database, that are associated or share a relationship with a second-type data item in the second database.

What it comes down to is, for each database Bᵢ, the following can be done for each first-type data item (known as the reference data item, aᵣ):

identify the set of second-type data items bᵢₗ that are associated with the said reference data item,

and (for each second-type data item associated with the said reference data item) identify the number Nᵢₗ of first-type data items related to them.

This operation can be carried out for each database, or in the unique database built up from all the databases, if the latter have been collated on a single server.

It is then possible to assign a weighting or a coefficient pᵢₗ(r) to each second-type data item bᵢₗ in a database Bᵢ for a given reference data item ar. This is a function of the number of data items of the first data type that are associated with it, within the same database.

A data item of the second type can have a weighting that becomes more important as the number of first-type data items associated with it decreases: the classification, i.e. the second-type data item, is thus considered to be good.

For example, the weighting for a second-type data item that is in the list of those related to the reference data item could be equal to the reciprocal of the number of first-type data items with which it is, associated.

For every second-type data item bᵢₗ related to the reference data item in database Bᵢ, the number of data items of the first type associated with the said second-type data item or having this second-type data item in common and the corresponding weight can be displayed on the screen of the user who is performing a search in the databases, based on the reference data item.

It would be equally possible to display the second-type data items associated with the reference data item and found in any of the databases, along with the number of data items of the first type associated with this second-type data item and the corresponding weightings.

The user could be given a means of deciding whether or not to retain a data item of the second type, for example a check box on screen, where he considers e.g. from personal experience that it will not contribute anything to the search.

He could also be given a means of increasing or decreasing the weighting (e.g. by selecting “+” and “−” tabs on screen) of one or other data item of the second type, again for example based upon his personal experience.

When the weights have been defined, each data item aᵢⱼ of the first data type that is in the set of items of the first type associated with at least one of the second-type data items related to the reference data item ar is assigned a score SFᵢⱼ(r) or coefficient as a function of the weights of the second-type data items with which it is associated.

Alternatively, it might be easier to select all data items of the first type from all the databases and to check, for each of these first-type data items, whether it is part of the set of such items that are related to at least one of the second-type data items associated with the reference data item. If not, the corresponding score is zero.

The score for each data item of the first data type can be a linear combination of the weights of the second-type data items with which it is associated, for example again being the sum of these weightings.

So, it is possible to classify the first-type data items as a function of this score or coefficient, for example in ascending in descending order.

Similarly it is possible to combine this score element SFᵢⱼ(r) for a first-type data item aᵢⱼ with one or several items deriving from the weights corresponding to this first-type data item.

For example, a final score sFᵢⱼ(r) can be calculated as a percentage, equal to the score divided by the sum of all the weights for the second-type data items associated with the reference data item
sFᵢⱼ(r)=SFᵢⱼ(r)/ΣᵢΣⱼpᵢⱼ(r)

The second-type data items can also be called the ‘sector-based criteria’.

The invention therefore also concerns a search procedure or method for data in one or more databases, or a multi-criteria search procedure or method in one or more databases, each of which relates data of the first data type to sector-based criteria (data of the second data type) comprising:

finding or selecting one or more sector-based criteria associated with a data item of the first type, known as the reference data item,

going through the database or databases to find the number of data items of the first type that correspond to each of the said criteria or are classified according to the said criteria,

allocation of a final score or coefficient to each of the first-type data items that matches at least one criterion, as a function of the frequency with which the said first-type data item appears with the said criteria.

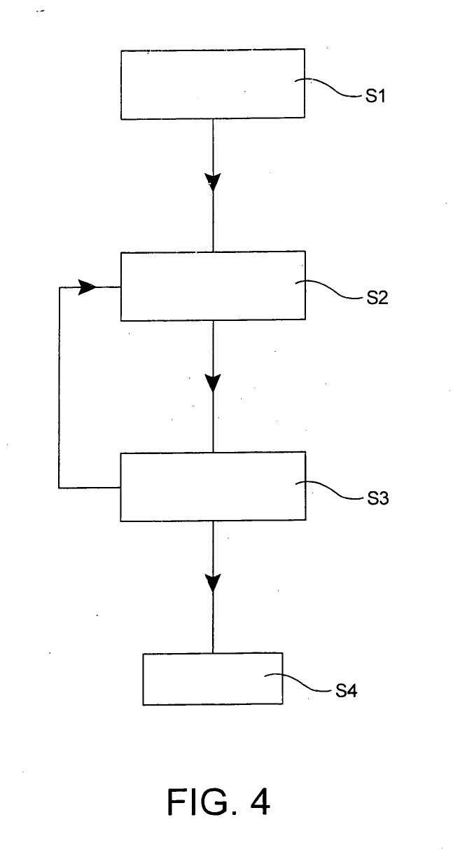

The steps of a procedure as per this invention are represented in FIG. 4:

in the first step, the user selects a data item of the first type, called the reference data item (step S1); a profile comprising of the data items of the second type associated with the reference data item in the various databases is retrieved from the various databases. A weighting can be assigned to each data item of the second type, as explained above; an initial weighting can be assigned by default;

the profile retrieved is displayed to the user (stage S2); he can remove second-type data items and modify the weights assigned to them; scores can be calculated for the data items of the first type, for the set of first-type data items in the database or databases, as explained above; these can be sorted in descending order;

these results can be presented to the user (step S3); for example, a predefined number N of data items of the first type can be displayed for him. The user will be able to modify the search parameters (remove data items of the first or second types, for example by going back to the preceding screen), in which case the procedure goes back to step S2;

when the user is satisfied, the procedure is terminated (step S4). The data can be saved or stored and the search results can be used.

A problem can arise when the reference data item ar does not appear in any of the databases.

In such an event, it is possible to make an initial selection of a certain number of data items of the first type which seem to correspond to the reference data item and which themselves are present in one or more databases, or all the databases. This initial selection can be made according to criteria that provide an approximation or according to the experience of the user. Data items of the second type are then selected that are related to these first-type data items.

More generally, a variant on the procedure given in this invention involves constructing a set of data items of the second type that are derived from one or more databases, related to data items of the first type that have themselves been selected as a function of some reference data item.

The following steps (calculation of the weightings, display, any changes required, calculation of one or more scores, etc.) remain identical to the ones already described previously.

An example will now be given, relating to the financial world.

The starting point for the search is a company that one of the users is interested in and which will hereinafter be referred to, as the reference company (reference data item).

The databases Bᵢ contain classifications such as for example the “Dow Jones”, NASDAQ or SIC, or NAICS, or FT (“Financial Times”), or MG or MSI financial classifications.

Each of these databases contains a sector-based classification. Each company indexed in the database is assigned to one or more classifications.

These classifications are the data items of the second type in the sense used above.

Starting with the reference company, all the sector classifications, i.e. all data items of the second type related to the reference data item are searched in all the databases.

A sector-based criterion for a financial database retrieves or reassembles all the companies in this database that have activities that are similar to those of the reference company.

Other additional classifications can also be used on top of the classical sector-based codes (SIC, NAICS, FT, DJ, GIGS), for example:

COMP, the list of direct competitors drawn up by the reference company themselves. This list of competitors can be codified and used to create a new list of companies,

REVERSECOMP, the reverse list of competitors. This refers to the list of companies that quote the reference company as being among their competitors. This sector therefore groups together not the direct competitors, but the companies who see the reference company as a competitor,

the distribution of turnover within the sector: some financial databases contain data on the companies' distribution of turnover within the sector. This turnover distribution can also be employed as a criterion.

During a second step, after having identified all the information for the classification, the engine presents the user with a summary screen that will allow the user to, validate and/or display the search criteria:

For each extended sector-based criterion, this screen displays a line containing items including:

the sort of classification sector class type),

the value the reference company has within this classification (generally a code),

the string literal for the code (the text describing the classification code),

a weighting that will allow the importance of the criterion within the search to be defined,

a selector allowing the user to include or exclude the criterion from the search.

The engine takes the multi-cardinality of the sector relationship into account, and it displays as many lines for a single classification as the company has values of the sector code. The screen will provide a visual representation of the primary sectors (those corresponding to the principal activity of the reference company).

By default, the weighting is pre-calculated to give a value directly linked to the relevance of the sector (in general, the size of the sector is sufficient as a criterion). The more relevant the sector is (and the more sharply defined), the heavier the weighting.

Each line that the user chooses is known as an extended sector criterion.

The third step involves the search.

The actual search algorithm is as follows, for example:

For each company in the database
Company score=0

For each extended sector criterion:

If the current company belongs to the same sector class:
Company score=Company score+extended sector criterion weighting
End if
End for
Re score:
   Company score=Company score/sum of all the extended sector criteria weightings for each extended sector criterion.

Next Company

The companies are then sorted by score in descending order and the N most relevant ones are shown to the user.

A procedure such as the one explained above in conjunction with FIG. 4 could be applied with the first type of data item being a company name and the second type of data item being the classifications of the companies in various classification databases.

In one variant, the reference data item is not a company. This is for example the case where the reference company is not indexed in any of the databases.

A set of companies is then defined as being associated with that company, the said set being produced for example by a previous retrieval from the databases.

For example, the reference company might have activities in the field of ball bearings, but it cannot be found in the databases. So, an initial search can be made of the databases, producing a set of companies that list “ball bearings” among their interests.

Starting from the set of companies thus defined, the sector profile search will be adapted to display all the sector-based criteria that turn up the most frequently in that set of companies.

To put it another way, the sector profile is not obtained by a search in the databases based on a reference company, but it is constructed from a set of companies that have at least one activity in common with the reference company.

Let us give an example illustrating the benefits of the invention. This example relates to the financial world and performs a search for companies that are comparable to a well-known firm in the petroleum sector, EXXON.

This company appears in the index of various databases and various classifications, for example Dow Jones, Financial Times, MG Industries, FT Sector, NAICS and SIC.

In each of these databases, the company belongs to a sector that can be identified by a code value.

For example, in the Dow Jones classification, EXXON is listed under “energy and petroleum producing companies”. 427 other companies are indexed for the same sector.

Under the Financial Times classification, EXXON is classed in a sector that is uniquely identified by a code number: 214.

Under the NAICS classification, EXXON is classed in multiple sectors that can be identified by either a code or a code and an associated textual string: the company belongs to sector 211, for example, but also to sector 211 111, this latter one having the title “extraction of raw petroleum and natural gas”.

Still within the NAICS classification, EXXON is indexed under sector number 324 and sector 324 11, the latter being called “petroleum refining”.

Other sectors are indicated in Table I below. It may be seen in this table that, within certain classifications such as NAICS or SIC, the same company may belong to multiple different sectors. Conversely, in other classifications such as the Dow Jones one, the company belongs to just a single sector. The same applies to the Financial Times classification.

The reference company, EXXON in this example, may have defined its own list of competitors. This list may or may not have been made available. In the case of EXXON, the company has made a list available consisting of 10 companies. This list has been integrated into Table I below, under the reference ‘COMP’.

Similarly, other companies may have stated EXXON as being one of their competitors. These companies are themselves a list, which can be identified per sector and incorporated into Table I below.

TABLE I

| | List of sectors | | | | |
|---|---|---|---|---|---|
| | | | | | Remove |
| | Sector | | Number of | | from |
| Sector | CODE | Text string | companies | Weighting | selection |
| COMP | 30238NU | Company's own list of | 10 | [symbol] 8 [symbol] | [symbol] |
| | | competitors (in USA only) | | | |
| REVCOMP | 30238NU | Other companies naming this | 169 | [symbol] 3 [symbol] | [symbol] |
| | | company as a competitor | | | |
| DJ | | Energy and oil-producing | 428 | [symbol] 3 [symbol] | [symbol] |
| | | companies | | | |
| FT | 214 | | 224 | [symbol] 3 [symbol] | [symbol] |
| MGINDUSTRY | 0606 | Petroleum and gas, integrated | 132 | [symbol] 3 [symbol] | [symbol] |
| MGSECTOR | 06 | Energy | 1402 | [symbol] 1 [symbol] | [symbol] |
| NAICS | 211111 | Crude Petroleum and Natural | 1009 | [symbol] 1 [symbol] | [symbol] |
| | | Gas Extraction | | | |
| NAICS | 211 | | 1206 | [symbol] 1 [symbol] | [symbol] |
| NAICS | 32411 | Petroleum refineries | 180 | [symbol] 3 [symbol] | [symbol] |
| NAICS | 324 | | 338 | [symbol] 3 [symbol] | [symbol] |
| NAICS | 44711 | Service stations with shops | 70 | [symbol] 6 [symbol] | [symbol] |
| NAICS | 447 | | 91 | [symbol] 6 [symbol] | [symbol] |
| NAICS | 483111 | Deep sea materials transport | 226 | [symbol] 3 [symbol] | [symbol] |
| NAICS | 483 | | 439 | [symbol] 3 [symbol] | [symbol] |
| NAICS | 48611 | Transport of crude oil by pipeline | 41 | [symbol] 6 [symbol] | [symbol] |
| NAICS | 486 | | 163 | [symbol] 3 [symbol] | [symbol] |
| NAICS | 325211 | Plastic materials and resin | 292 | [symbol] 3 [symbol] | [symbol] |
| | | manufacture | | | |
| NAICS | 325 | | 4075 | [symbol] 1 [symbol] | [symbol] |
| NAICS | 32511 | Petrochemical manufacturing | 117 | [symbol] 3 [symbol] | [symbol] |
| NAICS | 212112 | Natural extraction of bituminous | 70 | [symbol] 6 [symbol] | [symbol] |
| | | coal | | | |
| NAICS | 212 | | 2483 | [symbol] 1 [symbol] | [symbol] |
| NAICS | 212234 | Extraction of copper and nickel | 293 | [symbol] 3 [symbol] | [symbol] |
| | | ore | | | |
| NAICS | 221112 | Production of electrical energy | 184 | [symbol] 3 [symbol] | [symbol] |
| | | from fossil fuels | | | |
| NAICS | 221 | | 1453 | [symbol] 1 [symbol] | [symbol] |
| SIC | 2911 | Petroleum refining | 255 | [symbol] 3 [symbol] | [symbol] |
| SIC | 291 | | 296 | [symbol] 3 [symbol] | [symbol] |
| SIC | 1311 | Crude oil and natural gas | 1256 | [symbol] 1 [symbol] | [symbol] |
| SIC | 131 | | 1269 | [symbol] 1 [symbol] | [symbol] |
| SIC | 5541 | Service stations (fuel) | 91 | [symbol] 6 [symbol] | [symbol] |
| SIC | 554 | | 92 | [symbol] 6 [symbol] | [symbol] |
| SIC | 4412 | Deep Sea Foreign Transport of | 251 | [symbol] 3 [symbol] | [symbol] |
| | | Freight | | | |
| SIC | 441 | | 252 | [symbol] 3 [symbol] | [symbol] |
| SIC | 4612 | Crude oil pipelines | 37 | [symbol] 6 [symbol] | [symbol] |
| SIC | 461 | | 81 | [symbol] 6 [symbol] | [symbol] |
| SIC | 2821 | Plastics materials and resins | 329 | [symbol] 3 [symbol] | [symbol] |
| SIC | 282 | | 572 | [symbol] 2 [symbol] | [symbol] |
| SIC | 2869 | Industrial organic chemistry | 246 | [symbol] 3 [symbol] | [symbol] |
| SIC | 286 | | 359 | [symbol] 3 [symbol] | [symbol] |
| SIC | 1222 | Bituminous coal, underground | 76 | [symbol] 6 [symbol] | [symbol] |
| SIC | 122 | | 157 | [symbol] 3 [symbol] | [symbol] |
| SIC | 1021 | Copper ore | 279 | [symbol] 3 [symbol] | [symbol] |
| SIC | 102 | | 283 | [symbol] 3 [symbol] | [symbol] |
| SIC | 4911 | Electrical services | 643 | [symbol] 2 [symbol] | [symbol] |
| SIC | 491 | | 700 | [symbol] 2 [symbol] | [symbol] |
| WVB | E23 | Petroleum products/refineries | 99 | [symbol] 6 [symbol] | [symbol] |
| WVB | B1 | Chemicals, various | 555 | [symbol] 2 [symbol] | [symbol] |
| WVB | Z7 | Other | 3967 | [symbol] 1 [symbol] | [symbol] |

Other sectors can be created, for example based on the turnover breakdown for the reference company. In the example being considered, a proportion of EXXON's turnover relates to the fields of petroleum products and refineries, and another part relates to the various chemistry-based activities. Other companies might have all or part of their turnover in one or other of these two sectors.

These two activity sectors can therefore be seen as a classification element, each being used to group a certain number of companies together.

That is the reason why the last three lines in Table I above relate to sectors that group companies together that have a certain turnover within the sectors identified.

Table I above shows the number of companies identified for each sector.

A weighting coefficient is assigned to the sector; this coefficient may for example be inversely proportional to the number of companies identified in the sectors: if the sector contains lots of companies, then the sector is not so precise or it may not contain very much information, so its weighting will be relatively light. If, on the other hand, a sector does not contain many companies, then its weighting will be all the more important.

To take an example from Table I above: the NAICS sector 211, which lists 1206 companies, can be seen to have been assigned a weight of 1, whereas the SIC sector 4612 (crude oil pipelines), which groups just 37 companies together, has been assigned a more important weighting of 6.

A default weighting can be assigned to the sector, once the number of companies in the sector is known: this weighting is calculated automatically by the system. In Table I above, the user will see that he has the option of pressing a “+” or “−” button in the weights column, to modify the weighting attributed to one sector or another, according to his own experience and market knowledge.

In the last column, the user is even offered the option of removing a sector entirely, by unchecking one of the checked tick-boxes in the usual way.

Each of the companies in all the classifications (which could mean a large number of companies, in the region of 40,000 for example) is then selected one at a time and is compared with each of the sectors identified in Table I, in order to determine whether or not this company belongs to the sector being considered.

Initially, each company is assigned a “score” that is initialised to zero.

If the company belongs to the first sector, then the company's score is set to be equal to the weight of the first sector.

Equally, if it belongs to the second sector, then the company's score will be incremented by the weighting for the second sector.

If the company then does not belong to any of the subsequent five sectors, its score remains equal to the sum of the weightings for the first and second sectors.

If the company turns up again in the eighth sector, its score is incremented by the weight for the eighth sector and is therefore equal to the sum of the weights of the first, second and eighth sectors.

The examination of Table I for the company in question continues until the list of sectors in the table is exhausted.

The same comparison procedure is then carried out for every other company.

This results in each company having been allocated a “score”.

This score can be converted into a percentage, by relating it to the sum total of all the weights in Table I.

In this way, the reference company itself (EXXON in this case), which appears by definition in all the sectors in Table I, will necessarily get a score that is equal to the sum of all the weightings in Table I. Its final score is therefore 100%.

On the other hand, various other companies will have a final score of equal to or greater than 0 and less than 100%.

in the case of EXXON, this procedure led to 50 companies being identified that had a final score of between 24% and 100% (with 100% for the reference company itself). This set of companies has been grouped together in Table II below. It may be observed, logically enough, that the table includes well-known companies from the petroleum sector such as BP, TOTAL, REPSOL, SUNOCO, CHEVRON, ENI, etc.

TABLE II

| | | | | | | | Market | | |
|---|---|---|---|---|---|---|---|---|---|
| | | | | | | Turnover | capital'n | | Select |
| EF code | | | Company name | ISIN | Country | (in $M) | (in $M) | Score | all |
| 1 | 30238NU | [symbol] | Exxon Mobil | US30231G1022 | USA | 246,738 | 321,958 | 100% | [symbol] |
| | | | Corp | | | | | | |
| 2 | 30163NU | [symbol] | Sunoco, Inc | US86764P1093 | USA | 17,929 | N/A | 64% | [symbol] |
| 3 | 30081PC | [symbol] | Petrochina Co | CN0009365379 | CHN | 36,703 | 91,867 | 62% | [symbol] |
| 4 | 30295NU | [symbol] | Chevrontexaco | US1667641005 | USA | 112,937 | 114,006 | 59% | [symbol] |
| 5 | 90016EI | [symbol] | Eni | IT0003132476 | ITA | 85,254 | 82,210 | 53% | [symbol] |
| 6 | 30448NU | [symbol] | Unocal Corp | US9152891027 | USA | 6,539 | 10,815 | 45% | [symbol] |
| | | | Delaware | | | | | | |
| 7 | 00486EF | [symbol] | Total | FR0000120271 | FRA | 131,574 | 126,172 | 43% | [symbol] |
| 8 | 01571EX | [symbol] | BP | GB0007980591 | GBR | 232,571 | 210,589 | 42% | [symbol] |
| 9 | 30354NU | [symbol] | Amerada Hess | US0235511047 | USA | 14,480 | 8,002 | 41% | [symbol] |
| 10 | 91208EN | [symbol] | Royal Dutch | NL0000009470 | NLD | 201,728 | 107,684 | 41% | [symbol] |
| | | | Petroleum | | | | | | |
| 11 | 01809EX | [symbol] | Shell Transport | GB0008034141 | GBR | 2,429 | 74,728 | 41% | [symbol] |
| | | | & Trad | | | | | | |
| 12 | 32368NU | [symbol] | Tesoro | US8816091016 | USA | 8,846 | 1,912 | 39% | [symbol] |
| | | | Petroleum Corp | | | | | | |
| 13 | 01420EE | [symbol] | Espanola | ES0132580319 | ESP | 16,595 | 9,566 | 38% | [symbol] |
| | | | Petroleos (cepsa | | | | | | |
| 14 | 33549NU | [symbol] | GIANT | US3745081097 | USA | 1,808 | 280 | 38% | [symbol] |
| | | | INDUSTRIES | | | | | | |
| 15 | N2088OM | [symbol] | Shell Oman | OM0005514035 | OMN | 168 | N/A | 38% | [symbol] |
| | | | Marketing | | | | | | |
| | | | Company | | | | | | |
| | | | SAOG | | | | | | |
| 16 | 90005EE | [symbol] | Repsol | ES0173516115 | ESP | 45,348 | 26,084 | 38% | [symbol] |
| 17 | 30086PC | [symbol] | Sinopec | CN0005789556 | CHN | 51,267 | 34,462 | 36% | [symbol] |
| | | | corporation | | | | | | |
| 18 | 90005SF | [symbol] | Fortum | FI0009007132 | FIN | 14,323 | 12,053 | 35% | [symbol] |
| | | | Corporation | | | | | | |
| 19 | 30559NU | [symbol] | El Paso Corp | US28336L1098 | USA | 12,194 | 5,185 | 35% | [symbol] |
| 20 | 30174FT | [symbol] | Ptt Pcl | TH0646010007 | THA | 12,497 | N/A | 35% | [symbol] |
| 21 | 30806LB | [symbol] | Refinaria de | BRRIPIACNPR0 | BRA | 680 | N/A | 34% | [symbol] |
| | | | Petroleo | | | | | | |
| | | | Ipiranga S.A. | | | | | | |
| 22 | 01364KS | [symbol] | Sasol | ZAE000006896 | ZAF | 9,667 | 13,118 | 34% | [symbol] |
| 23 | 30025OR | [symbol] | OAO | RU0009033591 | RUS | 4,557 | 69,587 | 32% | [symbol] |
| | | | TATNEFT | | | | | | |
| 24 | 30236EI | [symbol] | Erg | IT0001157020 | ITA | 9,499 | 1,184 | 32% | [symbol] |
| 25 | M3082NU | [symbol] | Pride | US7415374013 | USA | 234 | N/A | 32% | [symbol] |
| | | | Companies, L.P. | | | | | | |
| 26 | 30004OF | [symbol] | Slovnaft | CS0009004452 | SVK | 1,655 | N/A | 32% | [symbol] |
| 27 | 30008LA | [symbol] | Ypf | ARP9897X1319 | ARG | 7,354 | N/A | 32% | [symbol] |
| | | | (Yacimientos | | | | | | |
| | | | Petroliferos Fi | | | | | | |
| 28 | 30011LC | [symbol] | Copec (Cia | CLP7847L1080 | CHL | 4,619 | N/A | 31% | [symbol] |
| | | | Petrol De Chile) | | | | | | |
| 29 | 32292NU | [symbol] | Lyondell | US5520781072 | USA | 3,801 | 3,659 | 31% | [symbol] |
| | | | Petrochemical | | | | | | |
| | | | Co | | | | | | |
| 30 | 30928AA | [symbol] | InterOil | CA4609511064 | CAN | 0 | N/A | 31% | [symbol] |
| | | | Corporation | | | | | | |
| | | | (CHESS) | | | | | | |
| 31 | 90038EN | [symbol] | DSM | NL0000009769 | NLD | 7,606 | 4,760 | 30% | [symbol] |
| 32 | 30005OR | [symbol] | Gazprom OAO | RU0007661625 | RUS | 19,222 | N/A | 30% | [symbol] |
| 33 | M1282NU | [symbol] | Holly | US4357583057 | USA | 1,403 | 735 | 29% | [symbol] |
| | | | Corporation | | | | | | |
| 34 | 30002OR | [symbol] | Lukoil Holding | RU0009024277 | RUS | 22,299 | N/A | 29% | [symbol] |
| 35 | 30349NU | [symbol] | Marathon Oil | US5658491064 | USA | 41,234 | 13,887 | 29% | [symbol] |
| | | | Corp | | | | | | |
| 36 | N7289CA | [symbol] | InterOil | CA4609511064 | CAN | 0 | N/A | 29% | [symbol] |
| | | | Corporation | | | | | | |
| 37 | 30080NU | [symbol] | ConocoPhillips | US20825C1045 | USA | 105,097 | 56,602 | 28% | [symbol] |
| 38 | 31061NU | [symbol] | Harken Energy | US4125523096 | USA | 27 | 115 | 28% | [symbol] |
| | | | Corp | | | | | | |
| 39 | 30539NU | [symbol] | Conoco | US2082515048 | USA | 38,737 | N/A | 28% | [symbol] |
| 40 | 30118EN | [symbol] | Petroplus | NL0000376937 | NLD | 7,685 | 299 | 27% | [symbol] |
| | | | International | | | | | | |
| 41 | 90002LA | [symbol] | Perez Companc | ARHOLD010025 | ARG | 1,908 | N/A | 27% | [symbol] |
| 42 | 33148NU | [symbol] | Transmontaigne | US8939341090 | USA | 8,324 | 249 | 26% | [symbol] |
| 43 | N3820BR | [symbol] | Dist. Produtos | BRDPPIACNPR5 | BRA | 3,609 | N/A | 26% | [symbol] |
| | | | de Petroleo | | | | | | |
| | | | Ipiranga S.A. | | | | | | |
| 44 | X0007LT | [symbol] | Mazeikiu Nafta | LT0000115552 | LTU | 1,926 | N/A | 26% | [symbol] |
| 45 | 30054PC | [symbol] | Sinopec Beijing | US82935N1072 | CHN | 1,386 | 63,971 | 25% | [symbol] |
| | | | Yanhua | | | | | | |
| 46 | 90262FJ | [symbol] | Iino Kaiun | JP3131200002 | JPN | 551 | N/A | 25% | [symbol] |
| | | | Kaisha | | | | | | |
| 47 | 30002OD | [symbol] | PETROL | SI0031102153 | SVN | 1,272 | N/A | 25% | [symbol] |
| | | | Ljubljana d.d. | | | | | | |
| 48 | 00007FK | [symbol] | Sk Corp | KR7003600004 | KOR | 11,541 | N/A | 25% | [symbol] |
| 49 | 20070NC | [symbol] | Enbridge Inc | CA29250N1050 | CAN | 3,752 | 7,100 | 24% | [symbol] |
| 50 | 30074FI | [symbol] | Reliance | INE002A01018 | IND | 12,004 | N/A | 24% | |
| | | | Industries | | | | | | |

A comparable example has been produced, for the same company (EXXON), using only Boolean criteria for combining the different classifications: the SIC classification has been retained, plus the Dow Jones and FT (Financial Times) classifications.

Table III below shows the code for the sector to which this company belongs for each of these three classifications.

TABLE III

| | |
|---|---|
| SIC sector: | 2911 |
| Dow Jones: | Energy |
| FT sector: | 214 |

These three classifications have been combined using a Boolean “AND”, the results of the intersection having been collated in Table IV below.

TABLE IV

| | | | Company | | | DJ | | |
|---|---|---|---|---|---|---|---|---|
| EF code | | | name | ISIN | Country | sector | SIC sector | FT sector |
| 1 | 30064FA | [symbol] | Alsons | PHY0093E1002 | PHL | Energy | 29 - petroleum | 214 - petroleum |
| | | | Consolidated | | | (3) | refining and | products/ |
| | | | Resour | | | | related industries | refineries |
| 2 | 30354NU | [symbol] | Amerada | US0235511047 | USA | Energy | 29 - petroleum | 214 - petroleum |
| | | | Hess | | | (3) | refining and | products/ |
| | | | | | | | related industries | refineries |
| 3 | 31213NC | [symbol] | Avatar | NA | CAN | Energy | 29 - petroleum | 214 - petroleum |
| | | | Petroleum | | | (3) | refining and | products/ |
| | | | Inc. | | | | related industries | refineries |
| 4 | 30963NU | [symbol] | Clark USA | NA | USA | Energy | 29 - petroleum | 214 - petroleum |
| | | | | | | (3) | refining and | products/ |
| | | | | | | | related industries | refineries |
| 5 | 30345LB | [symbol] | Companhia | NA | BRA | Energy | 29 - petroleum | 214 - petroleum |
| | | | Nordeste | | | (3) | refining and | products/ |
| | | | De | | | | related industries | refineries |
| | | | Participacoes - | | | | | |
| | | | Conepar | | | | | |
| 6 | 20042AA | [symbol] | Caltex | AU000000CTX1 | AUS | Energy | 29 - petroleum | 214 - petroleum |
| | | | Australia | | | (3) | refining and | products/ |
| | | | Ltd | | | | related industries | refineries |
| 7 | 30011LC | [symbol] | Copec (Cia | CLP7847L1080 | CHL | Energy | 29 - petroleum | 214 - petroleum |
| | | | Petrol De | | | (3) | refining and | products/ |
| | | | Chile) | | | | related industries | refineries |
| 8 | 00694FJ | [symbol] | Cosmo Oil | JP3298600002 | JPN | Energy | 29 - petroleum | 214 - petroleum |
| | | | Company | | | (3) | refining and | products/ |
| | | | Ltd | | | | related industries | refineries |
| 9 | 30022LO | [symbol] | Empresa | NA | BOL | Energy | 29 - petroleum | 214 - petroleum |
| | | | Petrolerachaco | | | (3) | refining and | products/ |
| | | | | | | | related industries | refineries |
| 10 | 30412LC | [symbol] | ENAP | NA | CHL | Energy | 29 - petroleum | 214 - petroleum |
| | | | | | | (3) | refining and | products/ |
| | | | | | | | related industries | refineries |
| 11 | 01420EE | [symbol] | Espanola | ES0132580319 | ESP | Energy | 29 - petroleum | 214 - petroleum |
| | | | Petroleos | | | (3) | refining and | products/ |
| | | | (cepsa) | | | | related industries | refineries |
| 12 | 90100EF | [symbol] | Esso | FR0000120669 | FRA | Energy | 29 - petroleum | 214 - petroleum |
| | | | (Francaise) | | | (3) | refining and | products/ |
| | | | | | | | related industries | refineries |
| 13 | 01112FM | [symbol] | Esso | MYL3042OO008 | MYS | Energy | 29 - petroleum | 214 - petroleum |
| | | | Malaysia | | | (3) | refining and | products/ |
| | | | Bhd | | | | related industries | refineries |
| 14 | 30238NU | [symbol] | Exxon | US30231G1022 | USA | Energy | 29 - petroleum | 214 - petroleum |
| | | | Mobil | | | (3) | refining and | products/ |
| | | | Corp | | | | related industries | refineries |
| 15 | 32126NU | [symbol] | Frontier | US35914P1057 | USA | Energy | 29 - petroleum | 214 - petroleum |
| | | | Oil Corp | | | (3) | refining and | products/ |
| | | | | | | | related industries | refineries |
| 16 | 30068EP | [symbol] | GALP | NA | PRT | Energy | 29 - petroleum | 214 - petroleum |
| | | | | | | (3) | refining and | products/ |
| | | | | | | | related industries | refineries |
| 17 | 30103FI | [symbol] | Hindustan | INE094A01015 | IND | Energy | 29 - petroleum | 214 - petroleum |
| | | | Petroleum | | | (3) | refining and | products/ |
| | | | | | | | related industries | refineries |
| 18 | 30205FI | [symbol] | Mangalore | INE103A01014 | IND | Energy | 29 - petroleum | 214 - petroleum |
| | | | Refinery & | | | (3) | refining and | products/ |
| | | | Petro | | | | related industries | refineries |
| 19 | 30683NU | [symbol] | Murphy | US6267171022 | USA | Energy | 29 - petroleum | 214 - petroleum |
| | | | Oil Corp | | | (3) | refining and | products/ |
| | | | | | | | related industries | refineries |
| 20 | 30465FJ | [symbol] | Nippon | NA | JPN | Energy | 29 - petroleum | 214 - petroleum |
| | | | Mitusubishi | | | (3) | refining and | products/ |
| | | | Oil | | | | related industries | refineries |
| | | | Corporation | | | | | |
| 21 | 00919FJ | [symbol] | Nippon Oil | JP3679700009 | JPN | Energy | 29 - petroleum | 214 - petroleum |
| | | | Co Ltd | | | (3) | refining and | products/ |
| | | | | | | | related industries | refineries |
| 22 | 30294PC | [symbol] | Offshore | NA | CHN | Energy | 29 - petroleum | 214 - petroleum |
| | | | Oil | | | (3) | refining and | products/ |
| | | | Engineering | | | | related industries | refineries |
| 23 | 90117EA | [symbol] | Omv Ag | AT0000743059 | AUT | Energy | 29 - petroleum | 214 - petroleum |
| | | | | | | (3) | refining and | products/ |
| | | | | | | | related industries | refineries |
| 24 | 91001FA | [symbol] | Oriental | PHY654111111 | PHL | Energy | 29 - petroleum | 214 - petroleum |
| | | | Petroleum | | | (3) | refining and | products/ |
| | | | & Mineral | | | | related industries | refineries |
| 25 | 30021EO | [symbol] | PKN | PLPKN0000018 | POL | Energy | 29 - petroleum | 214 - petroleum |
| | | | (Polski | | | (3) | refining and | products/ |
| | | | Koncern | | | | related industries | refineries |
| | | | Naftow | | | | | |
| 26 | 30806LB | [symbol] | Refinaria | BRRIPLACNPR0 | BRA | Energy | 29 - petroleum | 214 - petroleum |
| | | | de Petroleo | | | (3) | refining and | products/ |
| | | | Ipiranga S.A. | | | | related industries | refineries |
| 27 | 90005EE | [symbol] | Repsol | ES0173516115 | ESP | Energy | 29 - petroleum | 214 - petroleum |
| | | | | | | (3) | refining and | products/ |
| | | | | | | | related industries | refineries |
| 28 | 92574ED | [symbol] | Rwe Dea | DE0005509004 | DEU | Energy | 29 - petroleum | 214 - petroleum |
| | | | AG | | | (3) | refining and | products/ |
| | | | | | | | related industries | refineries |
| 29 | 30041LA | [symbol] | Sol | ARP8723U1058 | ARG | Energy | 29 - petroleum | 214 - petroleum |
| | | | Petroleo | | | (3) | refining and | products/ |
| | | | SA | | | | related industries | refineries |
| 30 | 01141FM | [symbol] | Shell | MYL4324OO009 | MYS | Energy | 29 - petroleum | 214 - petroleum |
| | | | Refining | | | (3) | refining and | products/ |
| | | | Co Fom | | | | related industries | refineries |
| 31 | 01006FJ | [symbol] | Showa | JP3366800005 | JPN | Energy | 29 - petroleum | 214 - petroleum |
| | | | Shell | | | (3) | refining and | products/ |
| | | | Sekiyu K.K. | | | | related industries | refineries |
| 32 | 90155FN | [symbol] | Singapore | SG1A07000569 | SGP | Energy | 29 - petroleum | 214 - petroleum |
| | | | Petroleum | | | (3) | refining and | products/ |
| | | | Co Ltd | | | | related industries | refineries |
| 33 | 30672FJ | [symbol] | Tonen | NA | JPN | Energy | 29 - petroleum | 214 - petroleum |
| | | | general | | | (3) | refining and | products/ |
| | | | Sekiyu K.K. | | | | related industries | refineries |
| 34 | 00732FJ | [symbol] | Tonen | JP3428600005 | JPN | Energy | 29 - petroleum | 214 - petroleum |
| | | | General | | | (3) | refining and | products/ |
| | | | Sekiyu | | | | related industries | refineries |

Surprisingly, this table does not mention any of the companies BP, TOTAL CHEVRON and SONOCO.

This example shows how the invention's procedure is more relevant, for a very well-known company such as EXXON, and allows companies comparable to EXXON to be targeted more effectively.

In the EXXON case, companies such as BP, SUNOCO, TOTAL and CHEVRON are well-known competitors. It would therefore have been possible to correct Table IV to include the missing well-known companies.

However, the reference company could be a much less well-known company, in which case it would become impossible to complete Table IV which is therefore what would be obtained. Using the procedure according to the invention, generating the data contained in Table II, can therefore provide a decisive advantage.

1. A method for searching for data through a plurality of databases, each of which containing a plurality of data items of a first given type, each associated with at least one data item belonging to a second data type, said method comprising:
A—entering a data item of the first data type, referred to as the reference data item,
b—searching in each database for:
B1—data items of the second type, associated with the reference data item,
B2—for each data item of the second type associated with the reference data item, the number of data items of the first type associated with said data item of the second type,
B3—allocating a coefficient known as the relevance weighting, function of the number of data items of the first type, to each set of data items of the first type associated with said data item of the second type.

2. A method for searching for data through a plurality of databases, each of which containing a plurality of data items of a first given type, each associated with at least one data item belonging to a second data type, said method comprising:
A—entry of a data item of the first data type, referred to as the reference data item,
B—the selection from said plurality of databases of data items of the second type, referred to as second data type items associated with the reference data item, followed by a search for:
B2—for each data item of the second type associated with the reference data item the number of data items of the first type associated with said data item of the second type,
B3—the allocation to each set of data items of the first type associated with said data item of the second type of a coefficient known as the relevance weighting, function of the number of data items of the first type associated with said data item of the second type.

3. A method as claimed in claim 1 or 2, further comprising a display step for each database and for each second data type item associated with the reference data item, for displaying the number of data items of the first type associated with this second data type item, along with the corresponding relevance weighting.

4. A method according to one of the above claims, further comprising displaying data items of the second type from all the databases associated with the reference data item, the number of data items of the first type associated with this second data type item, and the corresponding relevance weightings.

5. A method according to any of claims 1 through 4, further comprising the calculation of a relevance coefficient as a function of at least one relevance weighting, for at least each data item of the first type associated in at least one database.

6. A method according to claim 5, in which the relevance coefficient is calculated as a function of the sum of the relevance weightings given to the second data type items associated with the reference data item.

7. A method according to claim 6, further comprising displaying data items of the first type for which the relevance coefficient is not zero.

8. A method according to any one of the above claims, in which the first data type items are the names of companies.

9. A method according to claim 8, in which the databases are financial databases or databases related to stock exchanges.

10. A method according to claim 9, in which the databases contain at least the Dow Jones and/or CAC and/or Financial Times and/or NAICS and/or SIC classifications.

11. A method according to any of the above claims, in which the databases reside upon a single server.

12. A method according to one of claims 1 through 10, in which the databases reside upon different servers.

13. A device for searching for data through a number of databases, each of which contains a plurality of data items of a first given type, each associated with at least one data item belonging to a second data type, said device comprising:
a search means searching or selecting the following from each database:
data items of the second type, associated with the reference data item,
and, for at least one data item of the second type associated with the reference data item, the number of data items of the first type associated with said data items of the second type,
allocation means allocating to each set of data items of the first type associated with said data item of the second type a coefficient known as the relevance weighting, function of the number of data items of the first type associated with said data item of the second type.

14. A device as claimed in claim 13, further comprising display means displaying for each database and for each data item of the second type associated with the reference data item, the number of data items of the first type associated with this data item of the second type, along with the corresponding relevance weighting.

15. A device as claimed in claim 13 or 14, further comprising display means displaying data items of the second type from all the databases associated with the reference data item, the number of data items of the first type associated with this data item of the second type, and the corresponding relevance weightings.

16. A device as in any of claims 13 through 15, further comprising means calculating a relevance coefficient as a function of at least one relevance weighting, for at least each data item of the first type associated in at least one database.

17. A device as in claim 16, in which the relevance coefficient is calculated as a function of the sum of the relevance weightings given to the data items of the second data type items associated with the reference data item.

18. A device as in claim 17, further comprising display means displaying for each database and for each second data type item associated with the reference data item, the number of data items of the first type associated with this second data type item, along with the corresponding relevance weighting.

19. Computer program comprising the instructions for implementing a method according to any of claim 1 through 12.

20. Data storage media capable of being read by a computer system, having data stored thereon in encoded form for implementing a method according any of claims 1 through 12.

21. A computer related product comprising data storage media that can be read by a computer system, having thereon computer program code means allowing a method according to any of claims 1 through 12 to operate.
